(19) United States
(12) Patent Application Publication
(10) Pub. No.: US 2024/0112497 A1
(43) Pub. Date: Apr. 4, 2024

(54) CONNECTING GESTURE RECOGNITION WITH WEBRTC

(71) Applicant: RingCentral, Inc., Belmont, CA (US)

(72) Inventors: QingMing Xue, Xiamen (CN); Huang ZhongCan, Xiamen (CN); GengYu Li, Xiamen (CN)

(21) Appl. No.: 18/072,607

(22) Filed: Nov. 30, 2022

(30) Foreign Application Priority Data
Sep. 30, 2022 (CN) 2022112085895

(51) Int. Cl. G06V 40/20; G06V 20/40

(52) U.S. Cl. CPC G06V 40/20; G06V 20/44

(57) ABSTRACT

A computer-implemented method for identifying gestures in video from video conferencing applications is provided. The method comprises causing capture, by a video feed capture service, of data from a video conference session running on a video conferencing application. The method further comprises causing to write, by the video feed capture service, the data to a cache queue. A cache queue processing service moves the data from the cache queue to a location in shared memory. A gesture recognition service reads the data from the location in shared memory to determine whether a gesture is present within a video frame from the data. The gesture recognition service identifies a first gesture in the data. The method further comprises causing to send to the video conferencing application, by the gesture recognition service, the first gesture.

### BENEFIT CLAIM

This application claims the benefit of priority under 35 U.S.C. § 119 from China National Intellectual Property Administration application number 202211208589.5, filed Sep. 30, 2022, the entire contents of which is hereby incorporated by reference as if fully set forth herein.

### TECHNICAL FIELD

The present disclosure relates generally to the field of video conferencing. Specifically, the present disclosure relates to systems and methods for efficiently processing video data and identifying gestures within video data.

### BACKGROUND

Online meetings have become an essential part of everyday lives. For example, businesses use online meetings to discuss sensitive business matters, students use online meetings to exchange personal ideas and information, and friends and/or relatives use online meetings to engage in private conversations. Many online meetings are conducted using video conferencing software. Video conferencing adds a benefit of being able to see other participants during the meeting which results in a more engaging experience.

Currently, many video conferencing applications implement video processing algorithms to analyze incoming video and detect human gestures within the video. These gestures may include gestures such as a thumbs up, a head nod, arms waving, and any other type of gesture performed by a participant. Such gestures may be interpreted by a video processing algorithm to invoke certain video conference functions such as raising your hand for a question or toggling a mute button.

Video processing algorithms are configured to receive video data from a camera component, such as an embedded laptop camera, smartphone camera, or an external camera, and process the incoming video data by analyzing the data and converting the video data into displayable video. A video conferencing server may receive the displayable video and may forward the video to other participant devices to view. The processing demand of receiving video data, processing the video data, and converting the video data to send to the video conferencing server is handled by an internal processor of a participant's computing device.

One such drawback to having the participant's computing device handle the video processing demands is that the processing power and efficiency are limited by the capabilities of the participant's computing device. For example, if the participant's computing device is a smartphone or tablet, video processing speed may be affected when the video processing algorithm processes video data as well as performing other functions such as gesture recognition. As a result, the participant's computing device may suffer from processing bottlenecks associated with limited processing power and/or limited memory, leading to delayed video and/or buffering issues when sending video to the video conferencing server.

Therefore, there is a need for an improved video processing by participant devices when participating in a video conferencing session.

### SUMMARY

The appended claims may serve as a summary of the invention.

### BRIEF DESCRIPTION OF THE DRAWINGS

FIG. 1 is a network diagram depicting an online meeting system, in an example embodiment.

FIG. 2 is a block diagram that depicts an example computer system upon which embodiments may be implemented.

FIG. 3 is an expanded diagram of participant device, in an example embodiment.

FIG. 4 depicts a flowchart for identifying gestures in video from video conferencing applications, in an example embodiment.

FIG. 5 is an example diagram depicting interactions between services for identifying gestures in video from video conferencing applications, in an example embodiment.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IoT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood, that terms “user” and “participant” have equal meaning in the following description.

Embodiments are described in sections according to the following outline:
1.0 GENERAL OVERVIEW
2.0 STRUCTURAL OVERVIEW
   2.1 MEETING SERVER
   2.2 NETWORK
   2.3 PARTICIPANT DEVICES
   2.4 COMPUTER HARDWARE OVERVIEW
3.0 FUNCTIONAL OVERVIEW
   3.1 CONFERENCE MANAGEMENT SERVICE
   3.2 VIDEO FEED CAPTURE SERVICE
   3.3 CACHE QUEUE PROCESSING SERVICE
   3.4 GESTURE RECOGNITION SERVICE
4.0 PROCEDURAL OVERVIEW
   4.1 IDENTIFYING GESTURES
   4.2 NOTIFICATION PROCESSING FOR IDENTIFYING GESTURES

1.0 General Overview

Traditionally, video conferencing applications use process intensive video processing algorithms to process video in real-time. When video processing algorithms are enabled with enhanced capabilities, like gesture recognition, the video processing may become too resource intensive for computing devices to execute video conferencing applications. As a result, real-time video display may become delayed and/or interrupted.

The presently described approaches seek to address this computing resource bottleneck by implementing a shared memory area, on a computing device, designated for video data. The video data is then analyzed for gesture recognition without impacting real-time video display. Specifically, the technical solution provides a mechanism to reduce computing resource bottlenecks by separating real-time video processing and display from gesture recognition processing. By separating gesture recognition from real-time video processing, computing devices with limited processing resources may display real-time video and perform gesture recognition without having any performance impact on the real-time video display. Thereby providing a smoother video conferencing experience.

A computer-implemented method for identifying gestures in video from video conferencing applications is provided. In an embodiment, the method comprises causing capture, by a video feed capture service, of data from a video conference session running on a video conferencing application. The method further comprises causing to write, by the video feed capture service, the data to a cache queue. The method further comprises causing to move, by a cache queue processing service, the data from the cache queue to a location in shared memory. The method further comprises causing to read, by a gesture recognition service, the data from the location in shared memory to determine whether a gesture is present within a video frame from the data. The method further comprises causing to identify, by the gesture recognition service, a first gesture in the data. The method further comprises causing to send to the video conferencing application, by the gesture recognition service, the first gesture.

A non-transitory computer-readable medium storing a set of instructions is also provided. In an embodiment, when the set of instructions are executed by a processor the set of instructions cause: capturing, by a video feed capture service, data from a video conference session running on a video conferencing application; writing, by the video feed capture service, the data to a cache queue; moving, by a cache queue processing service, the data from the cache queue to a location in shared memory; reading, by a gesture recognition service, the data from the location in shared memory to determine whether a gesture is present within a video frame from the data; identifying, by the gesture recognition service, a first gesture in the data; sending to the video conferencing application, by the gesture recognition service, the first gesture.

A network-based computer system for identifying gestures in video from video conferencing applications is also provided. The system comprises a processor and a memory operatively connected to the processor. The memory stores instructions that, when executed by the processor, cause: capturing, by a video feed capture service, data from a video conference session running on a video conferencing application; writing, by the video feed capture service, the data to a cache queue; moving, by a cache queue processing service, the data from the cache queue to a location in shared memory; reading, by a gesture recognition service, the data from the location in shared memory to determine whether a gesture is present within a video frame from the data; identifying, by the gesture recognition service, a first gesture in the data; sending to the video conferencing application, by the gesture recognition service, the first gesture.

2.0 Structural Overview

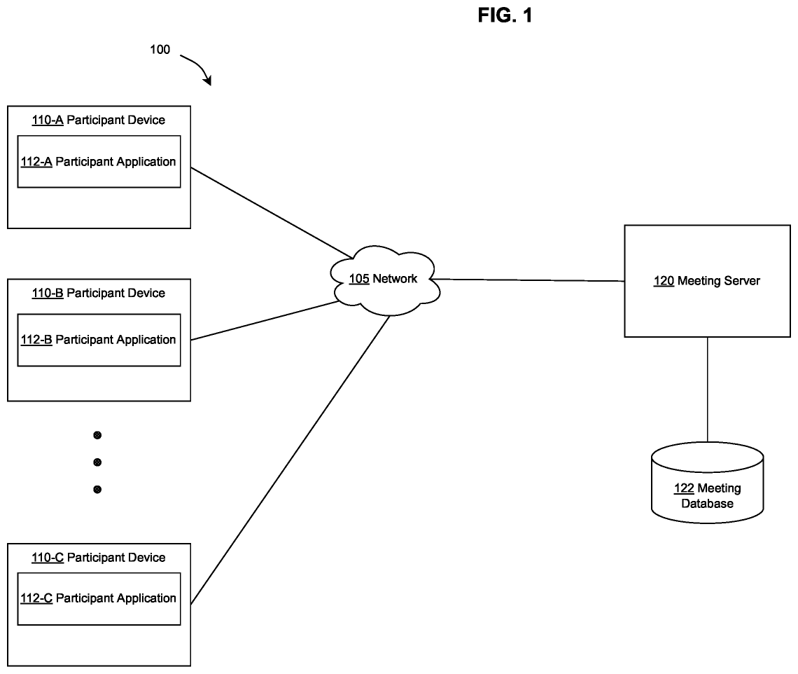

FIG. 1 is a network diagram depicting an online meeting system 100 in which various implementations, as described herein, may be practiced. The online meeting system 100 enables a plurality of participants to engage in an online meeting session in which video conferencing is enabled. In some examples, one or more components of the online meeting system 100, including participant devices 110-A, 110-B, 110-C, a meeting server 120, and a meeting database 122 may be used to implement computer programs, applications, methods, processes or other software to perform the described techniques and to realize the structures described herein. In an embodiment, the online meeting system 100 comprises components that are implemented at least partially by hardware at one or more computing devices, such as one or more hardware processors executing program instructions stored in one or more memories for performing the functions described herein.

As shown in FIG. 1, the online meeting system 100 includes one or more participant devices 110-A, 110-B, 110-C, a network 105, a meeting server 120, and a meeting database 122.

2.1 Meeting Server

In an embodiment, the meeting server 120 is configured to provide online meeting services, such as video conferencing, telephony, messaging, email, file sharing, and any other types of communication between users. The meeting server 120 may be communicatively coupled to the meeting database 122 for the purposes of storing online meeting data. The meeting database 122 may include one or more physical or virtual, structured or unstructured storages. The meeting database 122 may be configured to store communication data such as audio, video, text, or any other form of communication data. The meeting database 122 may also store security data, such as meeting participant lists, permissions, and any other types of the security data. While meeting database 122 is illustrated as an external device connected to the meeting server 120, the meeting database 122 may also reside within the meeting server 120 as an internal component of the meeting server 120.

2.2 Network

In an embodiment, the network 105 facilitates the exchange of communication and collaboration of data or any other type of information between participant devices 110-A, 110-B, 110-C, and the meeting server 120. The network 105 may be any type of network that provides communications, exchanges information, and/or facilitates the exchange of data between the meeting server 120 and participant devices 110-A, 110-B, 110-C. For example, the network 105 may represent one or more local area networks (LANs), wide area networks (WANs), metropolitan area networks (MANs), global interconnected internetworks, such as the public internet, public switched telephone networks (“PSTN”), or any other suitable connections or combinations thereof that enable the online meeting system 100 to send and receive information between the components of the online meeting system 100. Each such network 105 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 105 and the disclosure presumes that all elements of FIG. 1 are communicatively coupled via network 105. The network 105 may support a variety of electronic messaging formats, and may further support a variety of services and applications for the participant devices 110-A, 110-B, 110-C.

2.3 Participant Devices

Participant devices 110-A, 110-B, 110-C are configured to execute one or more participant applications 112-A, 112-B, 112-C that are configured to enable communication between the participant devices 110-A, 110-B, 110-C, and the meeting server 120. In some embodiments, the participant applications 112-A, 112-B, 112-C may be web-based applications that enable connectivity through a browser, such as through Web Real-Time Communications (WebRTC). In other embodiments, the participant applications 112-A, 112-B, 112-C may represent a standalone application. The meeting server 120 may be configured to execute server applications, such as a back-end application that facilitates communication and collaboration between the meeting server 120 and the participant devices 110-A, 110-B, 110-C.

In an embodiment, participant devices 110-A, 110-B, 110-C may represent a computing device such as a desktop computer, a laptop, a tablet, a smartphone, a smart television, and any other computing device having a display and audio/video capture capabilities. Participant devices 110-A, 110-B, 110-C may also include one or more software-based client applications that facilitate communications via instant messaging, text messaging, email, Voice over Internet Protocol (VoIP), video conferences, audio/video streaming, and so forth with one another.

2.4 Computer Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

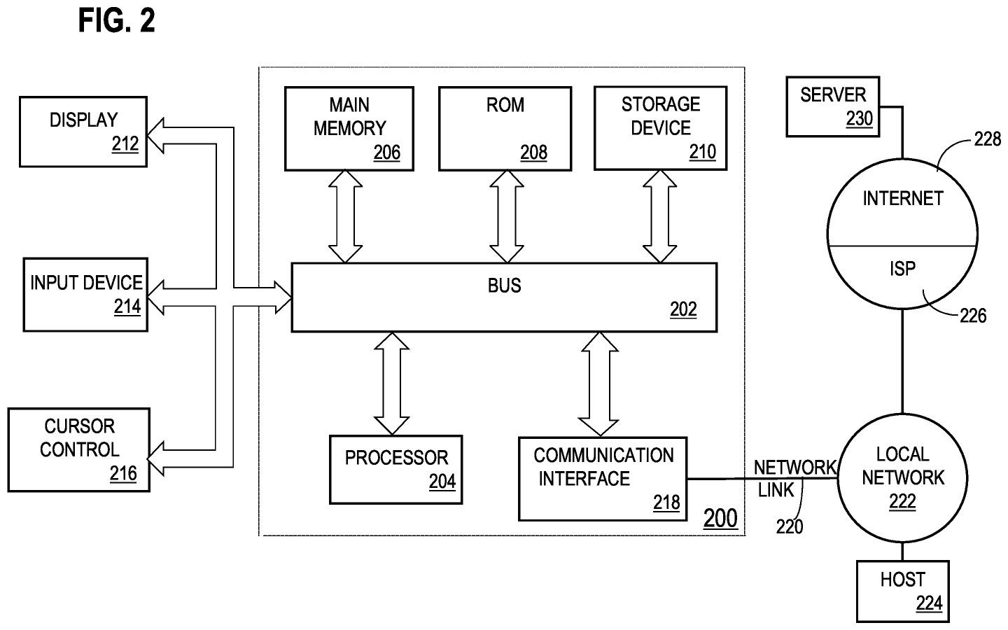

For example, FIG. 2 is a block diagram that illustrates a computer system 200 upon which an embodiment may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk, optical disk, or solid-state drive is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and/or program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 210. Volatile media includes dynamic memory, such as main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid-state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution.

3.0 Functional Overview

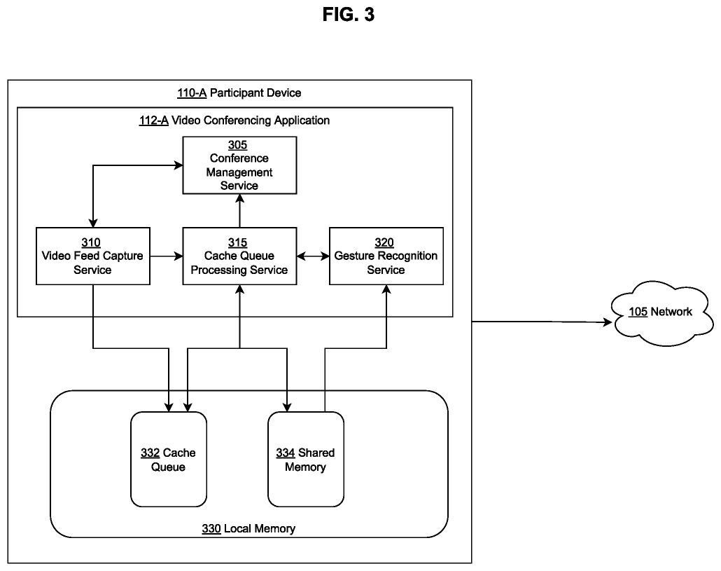

FIG. 3 is an expanded diagram of participant device 110-A, according to an embodiment. In an embodiment, participant device 110-A contains sets of instructions, services, or modules which, when executed by one or more processors, perform various functions related to processing video for the video conferencing application 112-A. Services and components reflected in FIG. 3 are not limited to participant device 110-A, and other participant devices 110-B and 110-C may also include similar sets of instructions, services, or modules which, when executed by one or more processors, perform various functions related to processing video for video conferencing applications 112-B and 112-C, respectively. In FIG. 3, participant device 110-A is configured with video conferencing application 112-A and local memory 330. Participant device 110-A, depicted in FIG. 3 represents just one illustrative example of a participant device and is not intended to be limited to having only the application and hardware components depicted in FIG. 3. Participant device 110-A may include other services and components, not currently displayed in FIG. 3, that assist with video processing and communication with the meeting server 120 and other participant devices 110-B and 110-C, such as a central processing unit (CPU) and a network interface controller.

Video data may represent any data associated with video captured by a video capture component, such as an integrated video camera or external video camera. Video data may include, but is not limited to, video frames, associated audio, and any metadata associated with the video captured, such as timestamps, location information, device capture information, and any other information.

In an embodiment, local memory 330 represents local volatile memory of participant device 110-A. Local memory 330 includes a shared memory 334 and a cache queue 332. Shared memory 334 may represent a dedicated set of data blocks designated specifically to store video data for the purposes of identifying gestures within the video. In an embodiment, shared memory 334 is configured to allow multiple processes to read data stored within the shared memory 334, but only allow a single process to write data to shared memory 334 at any given time. In other embodiments, shared memory 334 may be configured to allow multiple writes at any given time by certain designated processes and services.

In an embodiment, cache queue 332 may represent a dedicated area, within local memory 330, configured to store video data. The cache queue 332 may be a fixed size based on the available resources of participant device 110-A. For example, if participant device 110-A is a laptop computer then the cache queue 332 size may be greater than if participant device 110-A is a smartphone with limited local memory 330. The cache queue 332 is configured as a first-in-first-out queue where video data inserted into the cache queue 332 is removed from the cache queue 332 in the same order as it was inserted.

In an embodiment, video conferencing application 112-A includes a conference management service 305, a video feed capture service 310, a cache queue processing service 315, and a gesture recognition service 320. Other embodiments of the video conferencing application 112-A may include fewer or additional services and/or modules not currently depicted in FIG. 3.

In some embodiments, video conferencing application 112-A may represent a web-based application that enables connectivity through a browser, such as WebRTC. A WebRTC-based video conferencing application 112-A may include the conference management service 305, the video feed capture service 310, the cache queue processing service 315, and the gesture recognition service 320. For example, the WebRTC-based video conferencing application 112-A may invoke a WebRTC processing thread to manage functionality of the video conferencing application 112-A. The WebRTC processing thread may invoke separate processes configured to perform tasks associated with each of the conference management service 305, the video feed capture service 310, the cache queue processing service 315, and the gesture recognition service 320.

3.1 Conference Management Service

In an embodiment, the conference management service 305 is configured to manage active and scheduled conferencing sessions, process function call requests, and manage connections between the meeting server 120 and other participant devices 110-B and 110-C. The conference management service 305 may send and receive data to and from the meeting server 120, including, but not limited to, sending video data captured by participant device 110-A, receiving video data from the meeting server 120 generated by other participants of the session, invoking meeting functions such as muting, sending and receiving chat messages, raising a hand, and any other function that communicates with the meeting server 120. For instance, referring to FIG. 3, the conference management service 305 may receive from the video feed capture service 310 rendered video to be distributed to other meeting participants. The conference management service 305 may package video data into one or more network packets and send the network packets, via network 105, to the meeting server 120 for distribution to other meeting participants.

In an embodiment, the conference management service 305 is configured to receive requests to invoke meeting functions from the cache queue processing service 315. For example, the gesture recognition service 320 may send a response message to the cache queue processing service 315, which includes an identifier that identifies a particular gesture, such as a closed fist. The cache queue processing service 315 then sends a notification, with the identifier associated with the closed first gesture, to the conference management service 305. The conference management service 305 may receive the request, identify the particular gesture associated with identifier sent, and cause execution of a function associated with the particular gesture identifier. For instance, the identifier for the closed first may be associated with a mute function. Upon receiving the request that specifies the identifier for a closed fist, the conference management service 305 may trigger the function for muting the microphone associated with the video conferencing application 112-A. The mute function, or any other function, may cause an action on the video conferencing application 112-A and may cause a request to be sent to the meeting server 120. For example, the mute function may cause a request to be sent to the meeting server 120 that causes the meeting server 120 to notify all other video conferencing applications 112-B and 112-C that the participant using the video conferencing application 112-A is muted.

3.2 Video Feed Capture Service

In an embodiment, the video feed capture service 310 is configured to receive video data from a video capture device communicatively coupled to participant device 110-A and write the video data to cache queue 332 in local memory 330. A video capture device may include, but is not limited to, a camera device integrated into participant device 110-A and an external camera device communicatively coupled to participant device 110-A, such as an external wired camera as well as an external wireless camera. In an embodiment, the video feed capture service 310 may implement one or more computer processes to write the video data to the cache queue 332 as video is being captured in real-time. For example, an integrated camera on participant device 110-A captures video data of a participant engaged in a video conference session. The integrated camera may send the captured video data to the video feed capture service 310. The video feed capture service 310 may invoke a process configured to write the received video data to the cache queue 332 as the video is received.

Upon writing the video data to the cache queue 332, the video feed capture service 310 may render the captured video frames, from the video data, to generate displayable video that may be displayed on a video display device associated with participant device 110-A. For example, if participant device 110-A is a smartphone, then the video feed capture service 310 may render the captured video frames from the integrated camera to generate a real-time video that is displayed on a display screen integrated into participant device 110-A. In some cases, the rendering of the video frames may include incorporating additional elements into the video, such as graphical icons associated with the graphical user interface of the video conferencing application 112-A, virtual backgrounds, and any other video frame enhancements or add-ons.

In an embodiment, the video frame capture service 310 may provide the rendered video to the conference management service 305 for sharing the rendered video with other participant devices 110-B and 110-C. For example, the conference management service 305 may send the rendered video to the meeting server 120, via network 105. The meeting server 120 may then forward the rendered video to the other participant devices, participant devices 110-B and 110-C. The meeting server 120 may also store the rendered video, along with other rendered videos, from participant devices 110-B and 110-C, in meeting database 122. Alternatively, or in addition to sending the rendered video to the meeting server 120, the conference management service 305 may send the rendered video directly to participant devices 110-B and 110-C.

In an embodiment, upon writing video data to the cache queue 332, the video feed capture service 310 may notify the cache queue processing service 315 to process the video data in the cache queue 332. The cache queue processing service 315 is configured to read the video data stored in the cache queue 332 and move video frames from the cache queue 332 to shared memory 334. The video feed capture service 310 may be configured to notify the cache queue processing service 315 when the video feed capture service 310 starts capturing video. For instance, the conference management service 305 may receive input enabling video capture and may notify the video feed capture service 310 to start capturing video data using a camera device. The video feed capture service 310 may then notify the cache queue processing service 315 to start processing video data from the cache queue 332. As video data is written to the cache queue 332, by the video feed capture service 310, the cache queue processing service 315 is reading and processing video data from the cache queue 332. As the cache queue processing service 315 processes video data from the cache queue 332, the cache queue processing service 315 removes the processed video data from the cache queue 332 in a first-in-first-out order.

The cache queue 332 may become full if the cache queue processing service 315 does not process video data from the cache queue 332 as fast as the video feed capture service 310 writes video data to the cache queue 332. In an embodiment, if the cache queue 332 becomes full the video feed capture service 310 may bypass writing video data to the cache queue 332 and proceed to rendering the video data into displayable video. By bypassing the cache queue 332, the video feed capture service 310 may ensure that the real-time video feed displayed is not interrupted by processing delays from the cache queue processing service 315.

3.3 Cache Queue Processing Service

In an embodiment, the cache queue processing service 315 is configured to read the video data stored in the cache queue 332 and move video frames from the cache queue 332 to shared memory 334. The cache queue processing service 315 is implemented to reduce computing resource bottlenecks by separating real-time video processing and display from gesture recognition processing. Specifically, the cache queue processing service 315 moves video frames from the cache queue 332 to shared memory 334 for the gesture recognition processing, which is performed by the gesture recognition service 320. By separating gesture recognition processing from real-time video processing, which is performed by the video feed capture service 310, computing devices with limited processing resources may display real-time video and perform gesture recognition without having any performance impact on the real-time video display.

As discussed, video data may include video frames, associated audio data, and any other metadata. The cache queue processing service 315 is configured to identify video frames, from the video data, in the cache queue 332, and move the video frames to shared memory 334. Other video data, such as associated audio and metadata, may be filtered out and removed from the cache queue 332 without being written to shared memory 334. Shared memory 334 is configured to store video frames. Other video data is not stored within shared memory 334. For example, when cache queue processing service 315 reads video data from the cache queue 332, the cache queue processing service 315 determines the type of video data in the cache queue 332. If the video data is one or more video frames, then cache queue processing service 315 writes the one or more video frames to shared memory 334. If, however, the video data is other video data, then the cache queue processing service 315 removes the video data from the cache queue 332 but does not write the video data to shared memory 334.

In an embodiment, upon writing the video frames to shared memory 334, the cache queue processing service 315 may notify the gesture recognition service 320 to process the video frames written to shared memory 334. The notification sent to the gesture recognition service 320 may include location information for the video frames, such as a starting memory address for the newly written video frames. The gesture recognition service 320 may use the location information to locate the video frames for processing. In other embodiments, the notification sent to the gesture recognition service 320 may include, but is not limited to, a starting memory address of the video frames, a size of the video frames, a number of video frames written to shared memory 334, a timestamp, and any other information that may be useful for processing the video frames.

In an embodiment, the cache queue processing service 315 is configured to wait for a response message, from the gesture recognition service 320, in response to the notification sent by the cache queue processing service 315 before removing video frames from shared memory 334. The response message may be configured to include data indicating the type of gesture identified. For example, the cache queue processing service 315 may send a notification to the gesture recognition service 320 indicating that video frames have been stored in shared memory 334. The gesture recognition service 320 may analyze the video frames and determine that a thumbs up gesture is present. The gesture recognition service 320 may send, back to the cache queue processing service 315, a response message that contains an identifier identifying the thumbs up gesture. The cache queue processing service 315 may send the result from the response message, in this case the identifier representing the thumbs up gesture, to the conference management service 305. If, however, no gesture was identified from the video frames, then the response message from the gesture recognition service 320 may have a null value, indicating that no gesture was present.

In an embodiment, the cache queue processing service 315 may use the response message from the gesture recognition service 320 as an indicator to remove the processed video frames from shared memory 334. The cache queue processing service 315 is designated as the service that writes and deletes data from shared memory 334. Therefore, when the gesture recognition service 320 has successfully analyzed data in shared memory 334, the gesture recognition service 320 notifies the cache queue processing service 315, using the response message, to delete the processed video frames.

In an embodiment, the cache queue processing service 315 may be configured to periodically send notifications to the gesture recognition service 320 if the video frames written to shared memory 334 have not yet been processed. For example, if after 1 second, 2 seconds or any other period of time that can be set automatically or manually by a responsible user, video frames written to shared memory 334 have not yet been processed, then the cache queue processing service 315 may send another notification to the gesture recognition service 320 to ensure processing of video frames.

3.4 Gesture Recognition Service

In an embodiment, the gesture recognition service 320 is configured to analyze one or more video frames and identify the presence of a gesture within the one or more video frames. The gesture recognition service 320 reads, from shared memory 334, data representing the one or more video frames and determines whether a gesture exists within the one or more video frames.

A gesture may represent a hand gesture, a head gesture, a body gesture and facial expressions. For example, hand gestures include, but are not limited to, a thumbs up, a thumbs down, a closed fist, an open palm, a peace sign, and any other gesture that can be formed with hands and/or arms. Head gestures represent gestures made with the head and shoulders, such as a head nod, a head shake, shrugging shoulders, or any other head and shoulder position that may convey meaning. Facial expressions represent any movement of muscles in the face that cause the head and face to convey a message, such as a smile, a wink, a frown, and a biting of a lip. Certain gestures may be a combination of hand gestures, head gestures, and/or facial expressions. For example, placing one's hands on their cheeks while opening one's mouth may convey a gesture of surprise, which is a combination of hand gestures and a facial expression.

In an embodiment, the gesture recognition service 320 is configured to identify one or more gestures from one or more video frames stored in shared memory 334. The gesture recognition service 320 may implement any type of image recognition algorithm configured to identify gestures within images. For example, the gesture recognition service 320 may implement a machine learning model configured to identify gestures within one or more video frames. The machine learning models may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting. In other embodiments, the gesture recognition service 320 may implement any other algorithm configured to identify gestures within images.

Gestures may be linked to functions associated with the video conferencing application 112-A. For example, a thumbs up gesture may be linked to a function to display a thumbs up within the video displayed in the video conferencing application 112-A or for inserting a thumbs up icon in a chat window of the video conferencing application 112-A. Associations between gestures and functions may be defined and provided by the meeting server 120 to the video conferencing applications 112-A, 112-B, 112-C of participant devices 110-A, 110-B, 110-C, respectively. Additionally, each of the video conferencing applications 112-A, 112-B, 112-C may be configured within customized gesture functionality. For instance, a participant using participant device 110-A, may configure the video conferencing application 112-A to recognize a shrugging shoulders gesture to be linked to an “ask question” function that raises the participant's hand during a video conference session.

In an embodiment, the gesture recognition service 320 is configured to identify a gesture within one or more video frames and notify the cache queue processing service 315 to send a message to the conference management service 305 that a gesture is present. The gesture recognition service 320 may maintain a list of known gestures that are associated with a function in the video conferencing application 112-A. Each of the known gestures may be associated with a unique identifier used to identify the gesture. For instance, a thumbs up gesture may be associated with a “0101” identifier, while a “wink” gesture may be associated with a “0505” identifier. The unique identifiers may be sent, within a response message, to the cache queue processing service 315. The cache queue processing service 315 may then send a notification to the conference management service 305 to trigger execution of a specific function associated with the gesture. For example, if the gesture recognition service 320 identifies a thumbs up gesture within a video frame, the gesture recognition service 320 may send a response message to the cache queue processing service 315. The response message includes the unique identifier “0101” which is associated with the thumbs up. The cache queue processing service 315 may then send a request to the conference management service 305, where the notification includes the unique identifier “0101”. The conference management service 305 may receive the request, with the “0101” identifier, and may trigger a function call which toggles the thumbs up button within the video conferencing application 112-A.

In an embodiment, the gesture recognition service 320 may be configured receive a notification from the cache queue processing service 315, which instructs the gesture recognition service 320 to read data, representing video frames, from shared memory 334. The notification received by the gesture recognition service 320 may include location information for the video frames, such as a starting memory address in shared memory 334, as well as a size of the video frames, a number of video frames written to shared memory 334, a timestamp, and any other information that may be useful for processing the video frames. Upon receiving the notification from the cache queue processing service 315, the gesture recognition service 320 may locate the video frames, within shared memory 334, and process the video frames to determine whether a gesture exists and identify the gesture. In another embodiment, the gesture recognition service 320 may be configured to periodically poll share memory 334 for any new data objects representing new video frames to be processed.

4.0 Procedural Overview

4.1 Identifying Gestures

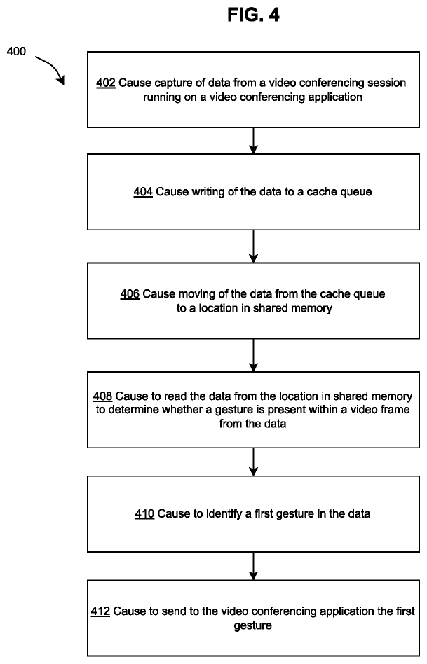

FIG. 4 depicts a flowchart for identifying gestures in video from video conferencing applications. Process 400 may be performed by a single program or multiple programs. The steps of the process as shown in FIG. 4 may be implemented using processor-executable instructions that are stored in computer memory. For the purposes of providing a clear example, the steps of FIG. 4 are described as being performed by computer programs executing on participant device 110-A. For the purposes of clarity process 400 is described in terms of a single entity.

In an embodiment, FIG. 4 depicts a video conferencing application running on participant device 110-A where a video conferencing session is taking place. The video conferencing session may be between two or more participants using participant devices 110-A, 110-B, 110-C.

At step 402, process 400 causes capture of data from a video conferencing session running on a video conferencing application. In an embodiment, the video conferencing application 112-A is running a video conferencing session in which video capture is enabled. The video feed capture service 310 receives data from a video capture device communicatively coupled to participant device 110-A. For example, if participant device 110-A is a laptop computer, then the video feed capture service 310 may receive data from an integrated camera installed on the laptop computer. The data received from the integrated camera may include video data such as video frames, associated audio, and any other associated metadata.

At step 404, process 400 causes writing of the data to a cache queue. In an embodiment, the video feed capture service 310 writes the data to cache queue 332. For example, the data received from the integrated camera is then written to the cache queue 332 by the video feed capture service 310. In an embodiment, upon writing video data to the cache queue 332, the video feed capture service 310 may send a notification to the cache queue processing service 315 to process the video data in the cache queue 332.

In an embodiment, upon writing the data to the cache queue 332, the video feed capture service 310 may render the data to generate displayable video that may be displayed on a video display device associated with participant device 110-A.

At step 406, process 400 causes moving of the data from the cache queue to a location in shared memory. In an embodiment, the cache queue processing service 315 moves the data from the cache queue 332 to a location in shared memory 334. If the data in the cache queue 332 is data representing video frames, then the cache queue processing service 315 moves the video frames from the cache queue 332 to a location in shared memory 334. If however, the data in the cache queue 332 includes other types of data, such as associated audio and/or metadata, then the cache queue processing service 315 selectively moves only video frames from the cache queue 332 to shared memory 334. Data that does not represent video frames may be removed from the cache queue 332.

Upon moving the video frames to shared memory 334, the cache queue processing service 315 notifies the gesture recognition service 320 that there is video data in shared memory 334 for processing. For example, the cache queue processing service 315 may send a notification message to the gesture recognition service 320, where the notification message include location information for the new video frames as well as any other relevant information, such as a timestamp and/or size of the video frames to be processed.

At step 408, process 400 causes reading of the data from the location in shared memory to determine whether a gesture is present within a video frame from the data. In an embodiment, the gesture recognition service 320 reads the data stored in shared memory 334 to determine whether a gesture is present in the data. For example, the gesture recognition service 320 reads and analyzes a series of video frames in shared memory 334 to determine whether a gesture exists.

At step 410, process 400 causes identification of a first gesture in the data. In an embodiment, the gesture recognition service 320 uses a gesture recognition algorithm to identify a gesture in a video frame. For example, the gesture recognition service 320 may identify an open hand gesture in a video frame that indicates that the participant wishes to turn off their video. The gesture recognition service 320 may send a response message, to the cache queue processing service 315, that includes an identifier, identifying the stop video hand gesture. If, however, the video frame does not contain an identified gesture, then the gesture recognition service 320 may send the response message back to the cache queue processing service 315 that includes a null value for the gesture. The cache queue processing service 315 may then delete the video frames, analyzed by the gesture recognition service 320, from shared memory 334.

At step 412 process 400 causes sending to the video conferencing application the first gesture. In an embodiment, the cache queue processing service 315, upon receiving the response message from the gesture recognition service 320, forwards the identifier representing the identified gesture to the conference management service 305. The conference management service 305 may trigger a function call associated with the gesture. For example, if the gesture is the open hand gesture indicating a request to stop video, the cache queue processing service 315 may receive a response message that includes an identifier, such as “0606”, or any type of command that identifies the open hand gesture. The cache queue processing service 315 may send a notification to the conference management service 305 that includes the “0606” identifier for the open hand gesture. The conference management service 305 may then invoke a function call that disables video capture.

4.2 Notification Processing for Identifying Gestures

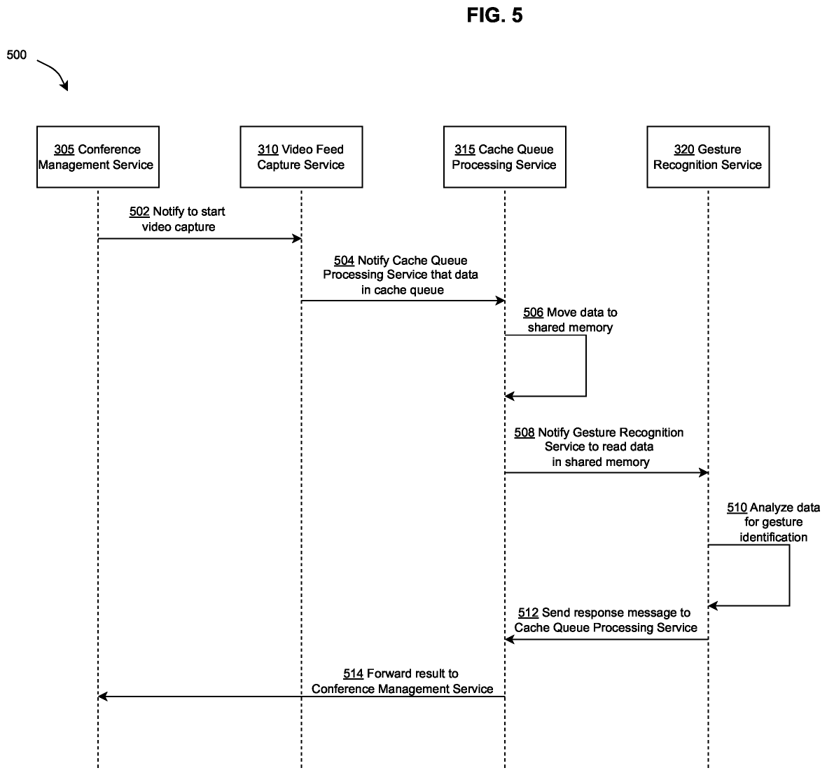

FIG. 5 is an example diagram depicting interactions between services for identifying gestures in video from video conferencing applications. Process 500 may be performed by a single program or multiple programs. The steps of the process as shown in FIG. 5 may be implemented using processor-executable instructions that are stored in computer memory. In this example diagram, services running on video conferencing application 112-A process incoming video to identify gestures within the video.

At step 502, process 500 sends a notification to start video capture. In an embodiment, the conference management service 305 sends a notification to the video feed capture service 310 to start capturing video data. The video feed capture service 310, in response to receiving the notification, starts capturing video data using a video capture device, such as an integrated camera.

At step 504, process 500 notifies the cache queue processing service 315 that data is in the cache queue 332. In an embodiment, the video feed capture service 310, upon capturing video data, writes the video data to the cache queue 322. Once written in the cache queue 332, the video feed capture service 310 sends a notification to the cache queue processing service 315 to process the video data in the cache queue 332.

At step 506, process 500 moves the data, from the cache queue 332, to shared memory 334. In an embodiment, the cache queue processing service 315 analyzes the video data in the cache queue 332 and moves at least a subset of video data, representing video frames, to a location in shared memory 334. The cache queue processing service 315 filters out and removes video data that is not video frames, such as associated audio and metadata.

At step 508, process 500 notifies the gesture recognition service 320 to read data in shared memory 334. In an embodiment, the cache queue processing service 315, upon writing the video frames to shared memory 334, sends a notification to the gesture recognition service 320 to process the video frames written to shared memory 334.

At step 510, process 500 analyzes the data for gesture identification. In an embodiment, the gesture recognition service 320 analyzes the video frames in shared memory 334 to identify one or more gestures. For example, if the video frames contained a thumbs up gesture, then the gesture recognition service 320 may identify the thumbs up as a gesture of interest.

At step 512, process 500 sends a response message to the cache queue processing service 315. In an embodiment, the gesture recognition service 320 sends a response message, containing the identified gesture, to the cache queue processing service 315. The cache queue processing service 315 uses the response message to indicate that the gesture recognition service 320 has processed the video frames and that the video frames may be deleted from shared memory 334.

At step 514, process 500 forwards the result of the gesture recognition to the conference management service 305. In an embodiment, the cache queue processing service 315 forwards the identified gesture to the conference management service 305. The response message received from the gesture recognition service 320 may include an identifier that represents the identified gesture. For example, the thumbs up gesture may be represented by integer “0101”. The cache queue processing service 315 sends a message containing the “0101” identifier, representing the thumbs up, to the conference management service 305.

In an embodiment, the conference management service 305, upon receiving the notification message from the cache queue processing service 315, identifies the gesture and triggers execution of a function associated with the gesture. For instance, if gesture identifier “0101” is received by the conference management service 305, the conference management service 305 may execute the function call for displaying a thumbs up in the video conferencing application 112-A.

What is claimed is:

1. A computer-implemented method for identifying gestures in video from video conferencing applications, the method comprising:
causing to capture, by a video feed capture service, data from a video conference session running on a video conferencing application;
causing to write, by the video feed capture service, the data to a cache queue;
causing to move, by a cache queue processing service, the data from the cache queue to a location in shared memory;
causing to read, by a gesture rQecognition service, the data from the location in shared memory to determine whether a gesture is present within a video frame from the data;
causing to identify, by the gesture recognition service, a first gesture in the data;
causing to send to the video conferencing application, by the gesture recognition service, the first gesture.

2. The computer-implemented method of claim 1, wherein the data represents one or more frames of video.

3. The computer-implemented method of claim 1, wherein causing to move the data to the location in the shared memory, comprises:
determining a subset of video data from the data, wherein the subset of video data comprises one or more video frames; and
causing to move the subset of video data to the location in the shared memory.

4. The computer-implemented method of claim 1, wherein the first gesture is one of a hand gesture, body gesture, or a facial gesture.

5. The computer-implemented method of claim 1, further comprising causing to send to the video conferencing application, by the gesture recognition service, a request to trigger a function call associated with the first gesture.

6. The computer-implemented method of claim 1, further comprising upon causing to write the data to the cache queue, causing to notify, by the video feed capture service, the cache queue processing service to process the data written to the cache queue.

7. The computer-implemented method of claim 1, further comprising upon causing to move the data to the location in the shared memory, causing to notify, by the cache queue processing service, the gesture recognition service to read the data in the location in the shared memory.

8. A non-transitory, computer readable medium storing a set of instructions for identifying gestures in video from video conferencing applications, that, when executed by a processor, cause:
capturing, by a video feed capture service, data from a video conference session running on a video conferencing application;
writing, by the video feed capture service, the data to a cache queue;
moving, by a cache queue processing service, the data from the cache queue to a location in shared memory;
reading, by a gesture recognition service, the data from the location in shared memory to determine whether a gesture is present within a video frame from the data;
identifying, by the gesture recognition service, a first gesture in the data;
sending to the video conferencing application, by the gesture recognition service, the first gesture.

9. The non-transitory, computer-readable medium of claim 8, wherein the data represents one or more frames of video.

10. The non-transitory, computer-readable medium of claim 8, wherein moving the data to the location in the shared memory, comprises:
determining a subset of video data from the data, wherein the subset of video data comprises one or more video frames; and
moving the subset of video data to the location in the shared memory.

11. The non-transitory, computer-readable medium of claim 8, wherein the first gesture is one of a hand gesture, body gesture, or a facial gesture.

12. The non-transitory, computer-readable medium of claim 8, wherein the non-transitory, computer-readable medium storing further instructions that, when executed by the processor, cause, sending to the video conferencing application, by the gesture recognition service, a request to trigger a function call associated with the first gesture.

13. The non-transitory, computer-readable medium of claim 8, wherein the non-transitory, computer-readable medium storing further instructions that, when executed by the processor, cause, upon writing the data to the cache queue, notifying, by the video feed capture service, the cache queue processing service to process the data written to the cache queue.

14. The non-transitory, computer-readable medium of claim 8, wherein the non-transitory, computer-readable medium storing further instructions that, when executed by the processor, cause, moving the data to the location in the shared memory, notifying, by the cache queue processing service, the gesture recognition service to read the data in the location in the shared memory.

15. A network-based system for identifying gestures in video from video conferencing applications, the system comprising:
a processor;
a memory operatively connected to the processor and storing instructions that, when executed by the processor, cause:
capturing, by a video feed capture service, data from a video conference session running on a video conferencing application;
writing, by the video feed capture service, the data to a cache queue;
moving, by a cache queue processing service, the data from the cache queue to a location in shared memory;
reading, by a gesture recognition service, the data from the location in shared memory to determine whether a gesture is present within a video frame from the data;
identifying, by the gesture recognition service, a first gesture in the data;
sending to the video conferencing application, by the gesture recognition service, the first gesture.

16. The system of claim 15, wherein moving the data to the location in the shared memory, comprises:
determining a subset of video data from the data, wherein the subset of video data comprises one or more video frames; and
moving the subset of video data to the location in the shared memory.

17. The system of claim 15, wherein the first gesture is one of a hand gesture, body gesture, or a facial gesture.

18. The system of claim 15, wherein the memory storing further instructions that, when executed by the processor, cause, sending to the video conferencing application, by the gesture recognition service, a request to trigger a function call associated with the first gesture.

19. The system of claim 15, wherein the memory storing further instructions that, when executed by the processor, cause, upon writing the data to the cache queue, notifying, by the video feed capture service, the cache queue processing service to process the data written to the cache queue.

20. The system of claim 15, wherein the memory storing further instructions that, when executed by the processor, cause, upon moving the data to the location in the shared memory, notifying, by the cache queue processing service, the gesture recognition service to read the data in the location in the shared memory.
